(19) United States
(12) Patent Application Publication
(10) Pub. No.: US 2006/0128366 A1
(43) Pub. Date: Jun. 15, 2006

(54) Communication system, handheld communication device and method for automatic call diverting

(75) Inventors: Xiang Zhao, Shanghai City (CN); David Ho, Taipei (TW)

Correspondence Address: BIRCH STEWART KOLASCH & BIRCH, PO BOX 747, FALLS CHURCH, VA, 22040-0747, US

(73) Assignee: Inventec Appliances Corporation

(21) Appl. No.: 11/110,778

(22) Filed: Apr. 21, 2005

(30) Foreign Application Priority Data
Dec. 9, 2004 (TW) 093138186

(51) Int. Cl. H04M 3/42

(52) U.S. Cl. 455/417

(57) ABSTRACT

A communication system includes a wireless network service, a bound telephone device, and a handheld communication device. In this case, the bound telephone device couples with the wireless network service, and the handheld communication device has a wireless network search module and a call divert module. The wireless network search module detects the wireless network service. When the wireless network service is detected by the wireless network search module, the call divert module executes a call divert setup to divert a call from the handheld communication device to the bound telephone device. In addition, a handheld communication device and a method for automatic call diverting are provided.

### BACKGROUND OF THE INVENTION

1. Field of Invention

The invention relates to a communication system, a handheld communication device and a method for automatic call diverting, and, in particular, to a communication system, a handheld communication device and a method for automatic call diverting, which cooperate with a wireless network service for achieving the automatic call diverting.

2. Related Art

With the progress of technologies, the electrical communication industry has invented various kinds of portable electrical devices. The portable electrical devices are usually minimized, multi-function, and easily operated. For example, the mobile phone, which is lightweight, thin and ingenious, has become one of the most popular electrical devices. Regarding to the portable electrical devices, the mobile phone is widely spread, such that almost everyone has his/her own mobile phone. Obviously, the mobile phone is an indispensable electrical product for the modern life.

The mobile phone utilizes the microwaves of radio frequency for transmitting voice signals. In practice, the mobile phone providers use the 900 MHz/1800 MHz GSM system, or the 1900 MHz PCS system. In other words, the mobile phone can be regarded as a radio station. When the mobile phone is turned on, it projects a microwave to register at the nearest base station. Thus, the base station can catch the location of the mobile phone. If the mobile phone is moved and finds another base station providing stronger microwaves, the mobile phone may project a microwave to register at this base station. When the mobile phone is called, the base station(s) can rapidly build a communication with the mobile phone. Once the communication is built, the mobile phone will project and receive the microwaves continuously. Therefore, after using the mobile phone over a long period of time, the health of the user may be seriously threatened.

It is therefore an important subject of the invention to provide a communication system, a handheld communication device and a method for automatic call diverting, which can solve the above-mentioned problem.

### SUMMARY OF THE INVENTION

In view of the foregoing, the invention is to provide a communication system, a handheld communication device and a method for automatic call diverting, which can automatically execute a call diverting setup so as to divert a call.

To achieve the above, a communication system of the invention includes a wireless network service, a bound telephone device, and a handheld communication device. The bound telephone device couples with the wireless network service. The handheld communication device has a wireless network search module and a call divert module. The wireless network search module detects the wireless network service. When the wireless network service is detected by the wireless network search module, the call divert module executes a call divert setup to divert a call from the handheld communication device to the bound telephone device.

In addition, the invention also discloses a handheld communication device, which includes a wireless network search module and a call divert module. The wireless network search module detects a wireless network service. The call divert module executes a call divert setup to divert a call from the handheld communication device to a bound telephone device when the wireless network service is detected by the wireless network search module.

The invention further discloses a method for automatic call diverting, which includes the following steps of: detecting and accessing a wireless network service by a handheld communication device, and executing a call divert setup to divert a call from the handheld communication device to a bound telephone device when the wireless network service is detected.

As mentioned above, since the invention provides a wireless network search module and a call divert module, which can automatically act, in the handheld communication device, a call can be automatically diverted from the handheld communication device to the bound telephone device. Thus, the period of utilizing the handheld communication device can be reduced. As a result, the effect to users caused by the microwave of the handheld communication device is decreased. In addition, the communication system, handheld communication device and method for automatic call diverting of the invention can automatically execute the call divert setup. Therefore, the troublesome manual setup procedures can be avoid, which is very convenient to the user.

### BRIEF DESCRIPTION OF THE DRAWINGS

The invention will become more fully understood from the detailed description given herein below illustration only, and thus is not limitative of the present invention, and wherein:

FIG. 1 is a schematic view showing a communication system according to a preferred embodiment of the invention; and

FIG. 2 is a flowchart of a method for automatic call diverting according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

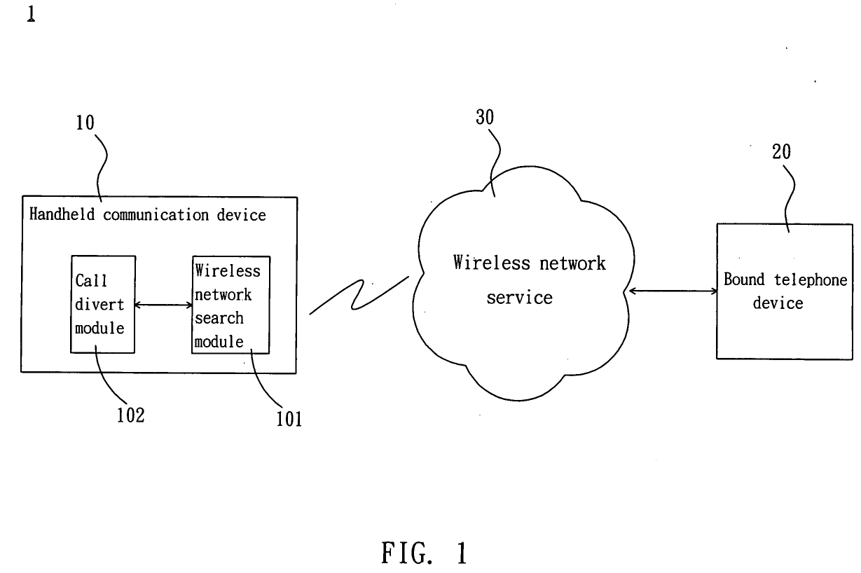

With reference to FIG. 1, a communication system 1 according to the embodiment of the invention includes a handheld communication device 10, a bound telephone device 20, and a wireless network service 30. In this embodiment, the wireless network service 30 is a Wi-Fi (Wireless fidelity) wireless network service. The wireless network service acts based on a wireless (Wi-Fi) communication protocol, such as IEEE 802.11a, IEEE 802.11b, or IEEE 802.11g.

In the present embodiment, the bound telephone device 20 is a corded telephone and is coupled to the wireless network service 30. In general, a gateway (not shown) is installed between the corded telephone and the wireless network service 30 for switching the voice signals. The gateway receives digital voice signals from the wireless network service 30. After the signal reconfiguration procedure, the de-packetization procedure, and the decompression procedure, the digital voice signals are transformed into analog voice signals. The analog voice signals are then transferred to the corded telephone through a PSTN (Public Switch Telephone Network) system. To be noted, the bound telephone device 20 of the invention is not limited to the corded telephone of the embodiment. For example, the bound telephone device 20 can be another handheld communication device.

The handheld communication device 10 includes a wireless network search module 101 and a call divert module 102. The wireless network search module 101 always searches that whether the wireless network service 30 is available or not. In more details, when the wireless network search module 101 receives a wireless signal from the wireless network service 30, it determines the wireless network service 30 is available. Then, an authentication procedure is performed to register the handheld communication device 10 at the wireless network service 30. That is, the handheld communication device 10 becomes one host of the wireless network service 30, so that the handheld communication device 10 can communicate with other hosts, such as notebook computers, via the wireless network service 30. After that, the call divert module 102 executes a call divert setup to divert a call from the handheld communication device 10 to any communication device in the wireless network service 30. The procedures of the call divert setup can be stored in the call divert module 102 in advance. In the current embodiment, the call divert module 102 can divert the call from the handheld communication device 10 to the bound telephone device 20 (the corded telephone).

As mentioned above, when the wireless network search module 101 of the handheld communication device 10 finds that the wireless network service 30 is available, the call divert module 102 immediately executes the call divert setup so as to divert a call from the handheld communication device 10 to the bound telephone device 20. As a result, the user can answer the call with the bound telephone device 20. Moreover, the user also can dial the bound telephone device 20 to make a call via the handheld communication device. If the handheld communication device 10 is carried away and leaves the scope of the wireless network service 30, the wireless network search module 101 can not receive the wireless signals from the wireless network service 30. In such a case, the wireless network search module 101 determines that the wireless network service 30 is unavailable, and the call divert module 102 automatically undoes the call divert setup.

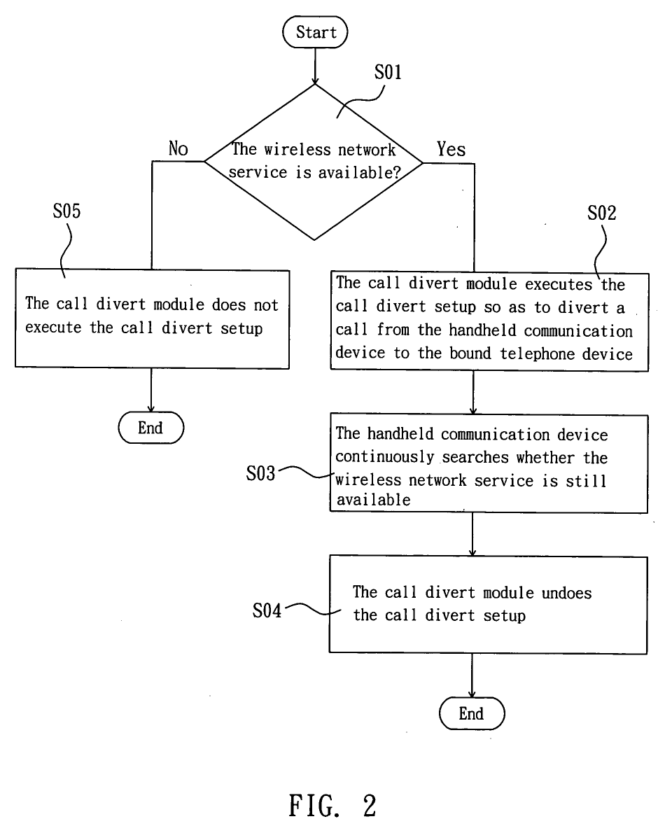

With reference to FIG. 2, a method for automatic call diverting according to a preferred embodiment of the invention is applied with the previously described communication system 1 and includes the following steps.

In a step S01, the handheld communication device 10 searches that whether the wireless network service 30 is available. In details, the handheld communication device 10 checks that whether to receive the wireless signals from the wireless network service 30. When the handheld communication device 10 receives the wireless signals, it determines the wireless network service 30 is available and a step S02 is then performed. If the handheld communication device 10 does not receive the wireless signals, it determines the wireless network service 30 is unavailable and a step S05 is then performed.

In the step S02, the call divert module 102 executes the call divert setup so as to divert a call from the handheld communication device 10 to the bound telephone device 20.

In a step S03, the handheld communication device 10 continuously searches whether the wireless network service 30 is still available. Once the wireless network service 30 is unavailable, a step S04 is then performed.

In the step S04, the call divert module 102 undoes the call divert setup.

In the step S05, the call divert module 102 of the handheld communication device 10 does not execute the call divert setup.

To make the invention more comprehensive, an example is described hereinafter for illustrating the method for automatic call diverting according the preferred embodiment of the invention. Herein, the communication system 1 shown in FIG. 1 is referred.

A salesman of a company, for instance, must call the customers frequently. When the salesman does not stay in the office, he usually uses a handheld communication device 10 to call the customers. Assuming that the communication system 1 is installed in the office, when the salesman enters the office, the wireless network search module 101 of the handheld communication device 10 starts to search that whether the wireless network service 30 is available (step S01). When the wireless network search module 101 determines that the wireless network service 30 is available, the handheld communication device 10 immediately performs an identification procedure to access the wireless network service 30. In this case, the call divert module 102 of the handheld communication device 10 automatically diverts a call from the handheld communication device 10 to the bound telephone device 20 (step S02). In the present embodiment, the bound telephone device 20 is a corded telephone. Since the call of the handheld communication device 10 is diverted to the corded telephone, the period that the user makes calls with the handheld communication device 10 can be reduced. As a result, the period of exposing the user to the microwave of the handheld communication device 10 can be decreased, so as to protect the user. In addition, when the wireless network search module 101 determines that the wireless network service 30 is unavailable, the call divert setup will not be executed (step S05).

Moreover, when the salesman leaves the office, the handheld communication device 10 can not search the available wireless network service 30. At this moment, the call divert module 102 will undo the call divert setup (step S04). Accordingly, the salesman can call the customers with the handheld communication device 10 as usual. In this case, the usage of the handheld communication device 10 is flexible. The handheld communication of the invention is similar to the above-mentioned handheld communication device 10, so the detailed descriptions are omitted for concise purpose.

In summary, since the invention provides a wireless network search module and a call divert module, which can automatically act, on the handheld communication device, a call can be -automatically diverted from the handheld communication device to the bound telephone device. Thus, the period of utilizing the handheld communication device can be reduced. As a result, the effect to users caused by the microwave of the handheld communication device is decreased. In addition, the communication system, handheld communication device and method for automatic call diverting of the invention can automatically execute the call divert setup. Therefore, the troublesome manual setup procedures can be avoid, which is very convenient to the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A communication system, comprising:
a wireless network service;
a bound telephone device coupling with the wireless network service; and
a handheld communication device having a wireless network search module and a call divert module, wherein the call divert module executes a call divert setup to divert a call from the handheld communication device to the bound telephone device when the wireless network service is detected by the wireless network search module.

2. The communication system of claim 1, wherein the wireless network service is a Wi-Fi wireless network service.

3. The communication system of claim 1, wherein the bound telephone device is a corded telephone.

4. The communication system of claim 1, wherein the bound telephone device is another handheld communication device.

5. The communication system of claim 1, wherein the wireless network search module detects the wireless network service based on a wireless (Wi-Fi) communication protocol.

6. The communication system of claim 1, wherein when the wireless network service is not detected and the call divert setup is executed, the call divert module undoes the call divert setup.

7. A handheld communication device, comprising:
a wireless network search module, which detects a wireless network service; and
a call divert module executing a call divert setup to divert a call from the handheld communication device to a bound telephone device when the wireless network service is detected by the wireless network search module.

8. The handheld communication device of claim 7, wherein the wireless network service is a Wi-Fi wireless network service.

9. The handheld communication device of claim 7, wherein the bound telephone device is a corded telephone.

10. The handheld communication device of claim 7, wherein the bound telephone device is another handheld communication device.

11. The handheld communication device of claim 7, wherein the wireless network search module detects the wireless network service based on a wireless (Wi-Fi) communication protocol.

12. The handheld communication device of claim 7, wherein when the wireless network service is detected and the call divert setup is executed, the call divert module undoes the call divert setup.

13. A method for automatic call diverting, which is applied in a handheld communication device, the method comprising:
detecting and accessing a wireless network service by the handheld communication device; and
executing a call divert setup to divert a call from the handheld communication device to a bound telephone device via the wireless network service.

14. The method of claim 13, further comprising:
undoing the call divert setup when the wireless network service is not detected and the call divert setup is executed.

15. The method of claim 13, wherein the bound telephone device is a corded telephone.

16. The method of claim 13, wherein the bound telephone device is another handheld communication device.

17. The method of claim 13, wherein the wireless network service is a Wi-Fi wireless network service.

18. The method of claim 13, wherein the step of detecting and accessing the wireless network service by the handheld communication device is performed based on a wireless (Wi-Fi) communication protocol.
